(19) United States
(12) Patent Application Publication
(10) Pub. No.: US 2002/0145728 A1
(43) Pub. Date: Oct. 10, 2002

(54) Method and apparatus for a spectrally stable light source using white light LEDs

(75) Inventors: John A. Adams, Escondido, CA (US); Robert A. Eaton, Scottsdale, AZ (US)

Correspondence Address: Snell & Wilmer LLP, One Arizona Center, 400 East Van Buren, Phoenix, AZ, 85004-2202, US

(73) Assignee: SpeedFam-IPEC Corporation

(21) Appl. No.: 09/828,038

(22) Filed: Apr. 6, 2001

(51) Int. Cl. G01J 3/50

(52) U.S. Cl. 356/72; 356/326; 356/402

(57) ABSTRACT

An apparatus and method for a spectrally stable light source is disclosed. An excitation source provides a spectrally stable light within a predetermined bandwidth. The spectrally stable light is directed at a reflective target. A light sensor receives reflected light from the surface of the target through the fiber optic cable and generates reflected spectral data. A computer receives the reflected spectral data and calculates a signal based on the reflected spectral data.

### FIELD OF THE INVENTION

The present invention relates to light sources and more particularly, to providing a spectrally stable light source.

### SUMMARY OF THE INVENTION

The present invention is directed at providing a spectrally stable light source and will be understood by reading and studying the following specification.

According to one aspect of the invention, the spectrally stable light source is a phosphor-based light source. Generally, an excitation source, such as a blue, Light Emitting Diode (LED), or a blue or violet laser, excites phosphors when placed within the light field emitted by the excitation source. The phosphors emit light at a lower energy, or larger wavelength than the excitation source. A light sensor receives reflected light from the surface of a target through the fiber optic cable and generates data corresponding to the spectrum of the reflected light. A computer receives the reflected spectral data and generates a signal as a function of the reflected spectral data. As compared with a tungsten bulb light source, the spectral shape of an excited phosphor-based light source remains spectrally stable as intensity changes through certain wavelength regions. This robustness makes the apparatus suitable for many applications, such as in situ EPD in a production environment.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a schematic illustration of an apparatus formed in accordance with the present invention;

FIG. 2 is a schematic diagram of a light sensor for use in the apparatus of FIG. 1;

FIG. 3 is a schematic sectional view a wLED according to an embodiment of the present invention;

FIG. 4 is a diagram showing a blue solid-state laser directed at a phosphor-coated plate according to an embodiment of the invention;

FIGS. 5A-5C are exemplary diagrams illustrating signal strength of a tungsten bulb source and a white light LED according to an embodiment of the invention;

FIGS. 6A-6B are exemplary diagrams illustrating spectral shifting of a tungsten bulb source and wLED according to one embodiment of the invention;

FIG. 7 is an exemplary diagram illustrating a typical spectrum of a white light LED according to an embodiment of the invention over a 113-hour time period;

FIG. 8 shows an exemplary spectral signature for a tungsten light source over a 113 hour time period;

FIG. 9 is an exemplary illustration of spectral stability of a white LED at various input current levels; and

FIG. 10 shows a logical flow for utilizing a spectrally stable light source to determine color of an object according to one embodiment of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

The present invention relates to a method and apparatus for a spectrally stable light source and a method of processing the optical data. For example, the present invention can be adapted for use in the CMP tool disclosed in U.S. Pat. No. 5,554,064, which is herein incorporated by reference.

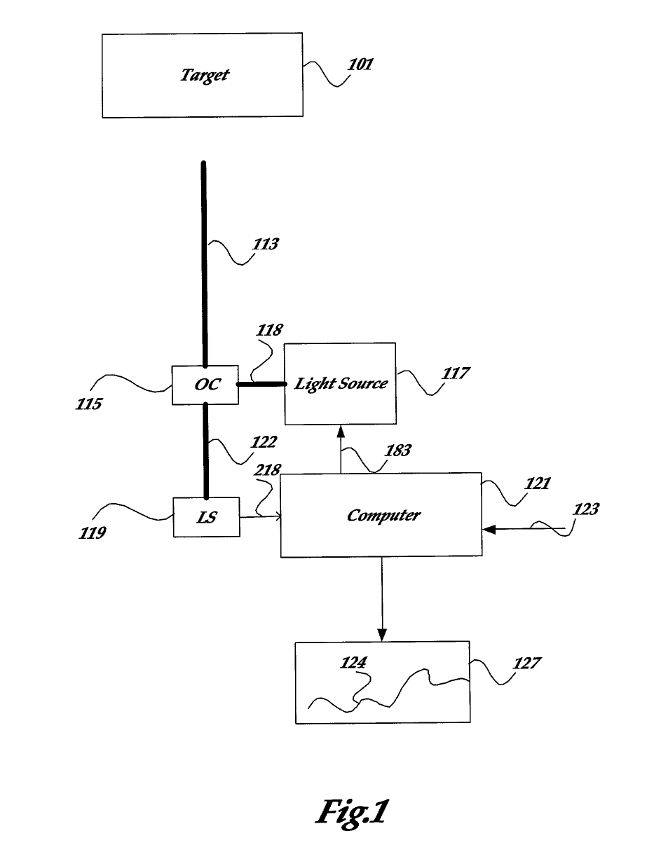

FIG. 1 illustrates a schematic representation of an overall system of a spectrally stable light source according to one embodiment of the present invention. A fiber optic cable assembly including a fiber optic cable 113 has one end of fiber optic cable 113 directed toward a reflective target 101. Fiber optic cable 113 can be embedded in a surface structure (not shown) for support.

Fiber optic cable 113 leads to an optical coupler 115 that receives light from a light source 117 via a fiber optic cable 118. In an embodiment of the invention, the light source 117 is butted up against the end of the fiber optic cable 118. The optical coupler 115 also outputs a reflected light signal to a light sensor 119 via fiber optic cable 122. In another embodiment, the light source 117 is directed through a light pipe (not shown). The reflected light signal is generated in accordance with the present invention, as described below.

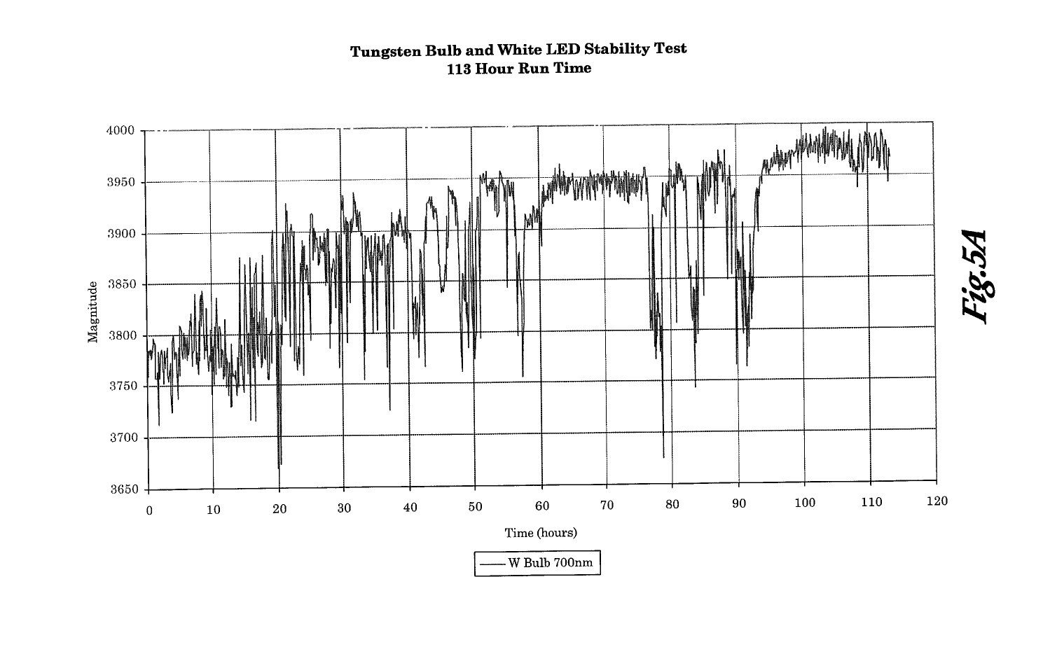

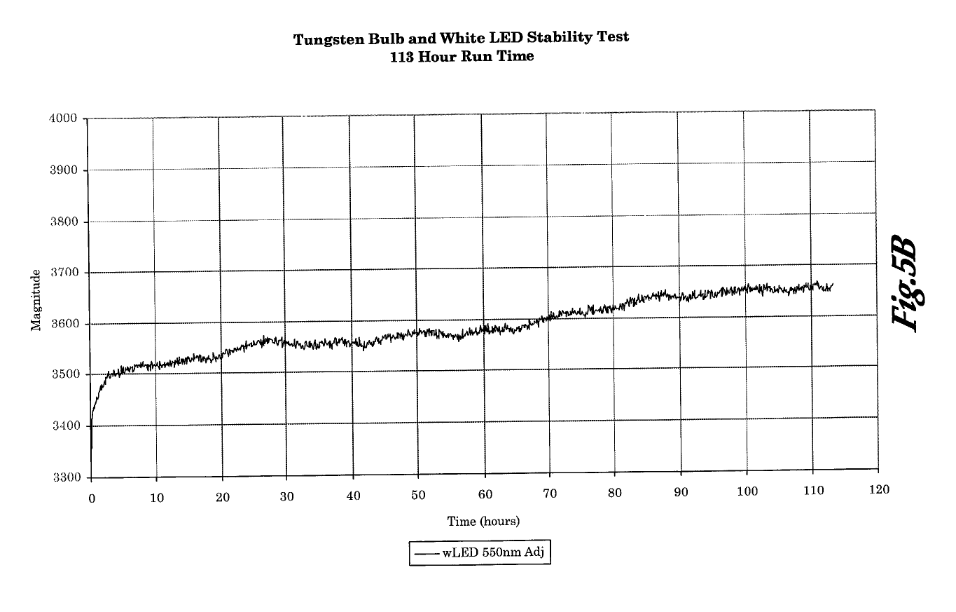

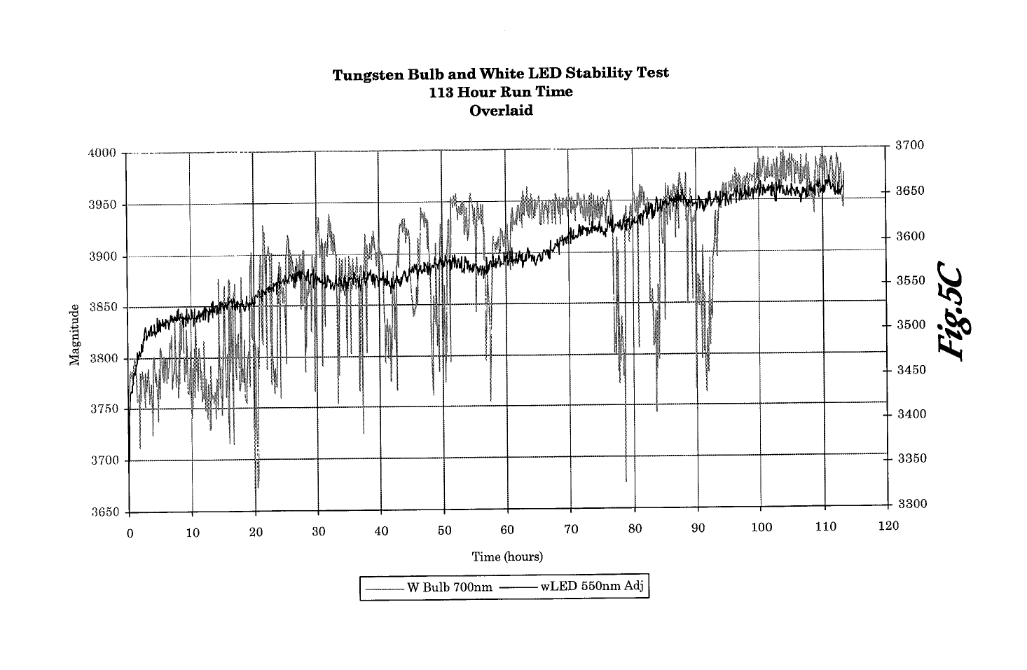

A computer 121 provides a control signal 183 to a spectrally stable light source 117 that directs the emission of light from the light source 117. In an embodiment of the invention, a Super Bright White LED (wLED) obtained from Nichia, product number NSPW500BS, is used as light source 117. The wLED light source is directed at providing a more stable spectral output as compared to bulb-type light sources, such as a tungsten bulb variable light source (See FIGS. 5-9 and related discussion). The basis of the spectral stability of the wLED is the phosphor material placed over a blue LED. The blue LED, an excitation source, provides the energy to excite the phosphors to emit photons. The particular phosphors are selected to emit photons over a specific spectral range. The LED drives the phosphors creating a spectrally stable output. Computer 121 also receives a start signal 123 that activates the light source 117. The computer may also provide executable steps for controlling light source 117 and interpretation of spectral data.

Computer 121 can synchronize the trigger of the data collection to the positional information from the sensors. A start signal 123 is provided to the computer 121 to initiate the process. Computer 121 then directs light source 117 to transmit light from light source 117 via fiber optic cable 118 to optical coupler 115. Alternatively, the computer 121 can direct light source 117 to transmit light from the light source 117 through a light pipe (not shown). For example, the light pipe could be a cylindrical solid glass rod, but may be any type of light pipe. This light in turn is routed through fiber optic cable 113 to be incident on the surface of the target 101.

Reflected light from the surface of the target 101 is captured by the fiber optic cable 113, or light pipe, and routed back to the optical coupler 115. Although in one embodiment the reflected light is relayed using the fiber optic cable 113, it will be appreciated that a separate dedicated fiber optic cable (not shown) may be used to collect the reflected light. Other methods as known to those skilled in the art may also be utilized. The return fiber optic cable would then preferably be adjacent to fiber optic cable 113 and housed in a single cable assembly.

The optical coupler 115 relays this reflected light signal through fiber optic cable 122 to light sensor 119. Light sensor 119 is operative to provide reflected spectral data 218, referred to herein as the reflected spectral data 218, of the reflected light to computer 121.

After a specified or predetermined time by the light sensor 119, the reflected spectral data 218 is read out of the detector array and transmitted to the computer 121, which analyzes the reflected spectral data 218.

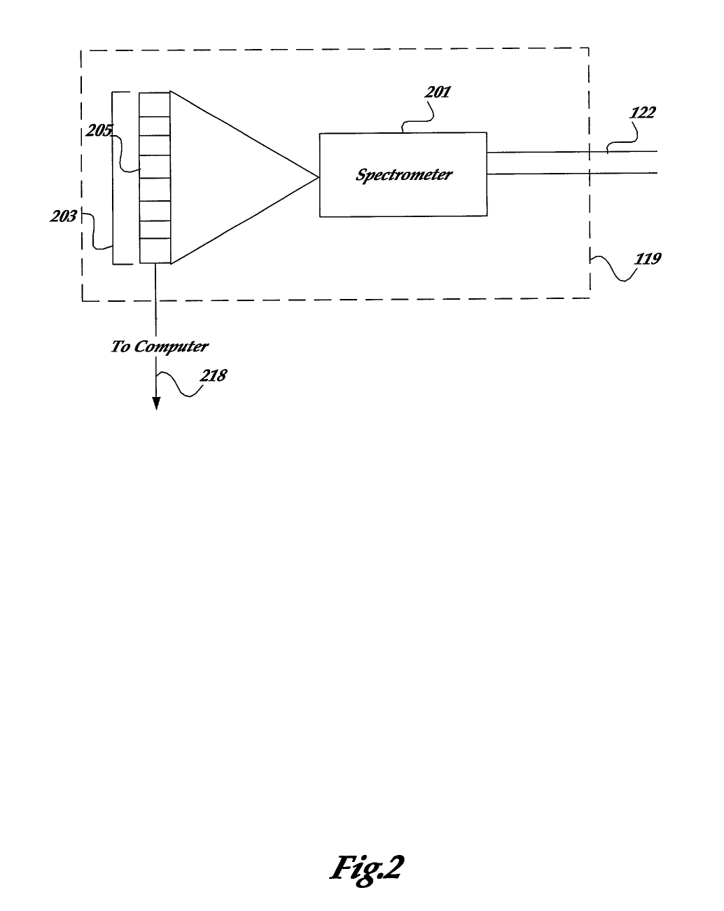

Turning to FIG. 2, the light sensor 119 contains a spectrometer 201 that disperses the light according to wavelength onto a detector array 203 that includes a plurality of light-sensitive elements 205. The spectrometer 201 uses a grating to spectrally separate the reflected light. The reflected light incident upon the light-sensitive elements 205 generates a signal in each light-sensitive element (or “pixel”) that is proportional to the intensity of light in the narrow wavelength region incident upon said pixel. The magnitude of the signal is also proportional to the integration time. Reflected spectral data 218 indicative of the spectral distribution of the reflected light is output to computer 121.

It will be appreciated by those of ordinary skill in the art, that, by varying the number of pixels 205, the resolution of the reflected spectral data 218 may be varied. For example, if the light source 117 has a total bandwidth of between 200 to 1000 nm, and if there are 980 pixels 205, then each pixel 205 provides a signal indicative of a wavelength band spanning 10 nm (9800 nm divided by 980 pixels). By increasing the number of pixels 205, the width of each wavelength band sensed by each pixel may be proportionally narrowed.

Computer 121 may provide logic for several signal-processing techniques used for reducing the noise in reflected spectral data 218. For example, a technique of single-spectrum wavelength averaging can be used. In this technique, the amplitudes of a given number of pixels within the single spectrum and centered about a central pixel are combined mathematically to produce a wavelength-smoothed data spectrum. For example, the data may be combined by simple average, boxcar average, median filter, gaussian filter, or other standard mathematical means when calculated pixel by pixel over the reflected spectral data 218.

Alternatively, a time-averaging technique may be used on the spectral data from two or more scans. In this technique, the spectral data of the scans are combined by averaging the corresponding pixels from each spectrum, resulting in a smoother spectrum.

In another technique, the amplitude ratio of wavelength bands of reflected spectral data are calculated using at least two separate bands consisting of one or more pixels. In particular, the average amplitude in each band is computed and then the ratio of the two bands is calculated. This technique tends to automatically reduce amplitude variation effects since the amplitude of each band is generally affected in the same way while the ratio of the amplitudes in the bands removes the variation.

In view of the present disclosure, one of ordinary skill in the art may employ other means, to process reflected spectral data 218 to obtain a smooth data result. For example, techniques of amplitude compensation, instrument function normalization, spectral wavelength averaging, time averaging, amplitude ratio determination, or other noise reduction techniques known to one of ordinary skill in the art, can be used individually or in combination to produce a smooth signal.

Further processing on a spectra-by-spectra basis may be required in some cases. For example, this further processing may include determining the standard deviation of the amplitude ratio of the wavelength bands, further time averaging of the amplitude ratio to smooth out noise, or other noise-reducing signal processing techniques that are known to one of ordinary skill in the art.

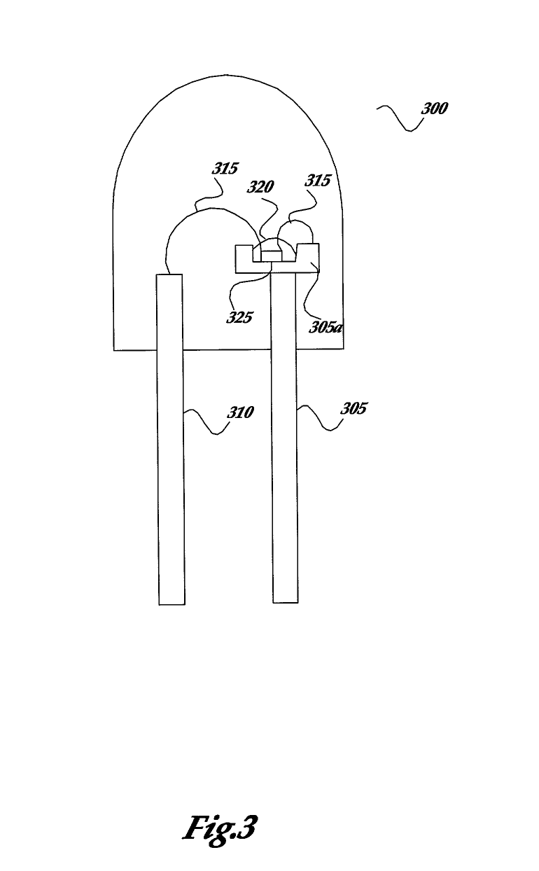

FIG. 3 is a schematic sectional view of a light-emitting device wLED 300. In one embodiment of the present invention, a wLED is used as light source 117 (FIG. 1). wLED 300 is a lead type LED having a mount lead 305 and inner lead 310. A light-emitting component 325, an excitation source, is installed on a cup 305a of the mount lead 305. Wires 315 connect the light emitting component 325 to the mount lead 305 and inner lead 310. A coating resin containing a phosphor 320 fills the cup 305a and covers the light-emitting component 325. In one particular embodiment of the invention the light-emitting component 325 is a blue LED. When the light-emitting component 325 is active (turned on) the light emitted excites the phosphor 320 generating a fluorescent light having a wavelength different from that of the light-emitting component 325. In another embodiment, the wLED 300 is a chip type light emitting diode in which a light-emitting component is installed in a recess of a casing filled with phosphor (not shown).

In one embodiment of the invention, the light source 117 is a wLED, with a spectrum of light between 200 and 1000 nm in wavelength, and more preferably with a spectrum of spectrally stable light between 600 and 800 nm in wavelength. The wLED is butted up against the end of the fiber optic 118 to propagate the light. It will be appreciated that, if a lower or wider spectral width is desired for the light source, lasers or LEDs, or any other excitation source, can be used as an excitation source to excite phosphors having wavelengths lower than the excitation source. This will excite the phosphors causing the phosphors to emit photons over the desired wavelength region. It will be appreciated by those of ordinary skill in the art that Super Bright White LEDs (wLED) are readily available for purchase. In addition to providing a spectrally stable light source, LEDs have a longer use life and are more uniform from one LED to the next, as compared to variable light sources. For example, the light intensity from one LED to the next will generally be in the same magnitude range whereas a VLS may vary by more than 50%.

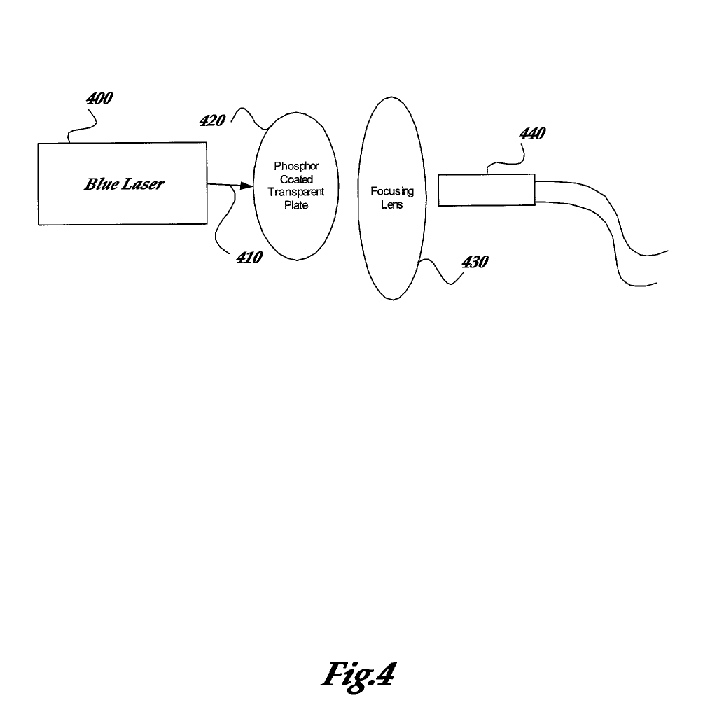

FIG. 4 is a diagram showing a blue solid-state laser as an excitation source directed at a phosphor-coated plate according to an embodiment of the invention. A blue solid-state laser 400 emits a blue laser 410 directed toward a phosphor coated transparent plate 420. A focusing lens 430 is placed between the phosphor coated transparent plate 1020 and a receiving fiber optic cable 440 to focus down the spectral output from the phosphor-coated plate. In another embodiment of the invention, the receiving fiber optic cable 440 may be replaced with a light pipe or similar device. Additionally, a blue light source is not required to excite the phosphors. An electron source of sufficiently short wavelength or of sufficiently high energy may be used to illuminate the phosphors. For example, a cathode ray tube or violet laser may be used as an excitation source to illuminate the phosphors.

Preferably the phosphor is chosen to emit light within a spectral region of interest with the excitation source being of shorter wavelength than the spectral region of interest. The phosphors may be selected and/or mixed such that they provide many different colors and response characteristics. The plate that the phosphors are attached to may work as a filter eliminating the wavelengths associated with the phosphor illumination source. According to this particular embodiment, the wavelengths associated with the blue laser may be eliminated. Additionally, to achieve shorter spectral wavelengths, the excitation source and the phosphors can be chosen that emit at shorter wavelengths. An advantage of the spectral stability of the illuminated phosphors results in smaller variations in end point detection times as compared to VLS. Other advantages of the wLED over a VLS include lower power consumption requirements as well as life expectancy of the light source.

The phosphor based light source may be extended to many different applications. Any optically based system can benefit from the use of the phosphor based light source. For example, the phosphor based light source may be used in spectroscopy. The phosphors may be mixed to produce the desired spectral range and signature. In another embodiment, the phosphor light source is used for absorption and reflection spectral measurements.

FIGS. 5A-5C are diagrams illustrating signal strength of a wLED and a variable light source (VLS). In this particular example, the signal strength of a wLED is compared with the signal strength of a tungsten light source over a 113 hour run time period. More specifically, the tungsten light source is run at the 100% Tungsten Set point, which is approximately 4.72 V, and 20mA is used for the set point for the wLED. The signal strength of both light sources is recorded every 0.1 hours over the 113 hour time period. FIG. 5A shows the signal strength of the tungsten light source. As can be seen, the signal strength of the tungsten light source varies widely between similar time periods. For example, at the 20 hour time point the signal strength varies between 3660 and 3900. At its most stable point, the variance is still significant. FIG. 5B shows the signal strength of a wLED. The signal strength of the wLED is more stable than the tungsten light source over the entire 113-hour run period. FIG. 5C is FIG. 5B overlaid on FIG. 5A. Referring to FIG. 5C, it is apparent that the wLED's signal strength is more stable than the tungsten light. As can be seen by referring to FIG. 5C, at its most stable points, the tungsten light source is less stable than the wLED during any point of the time period. Additionally, the level of noise, or instantaneous variation in intensity level, is lower for the wLED as compared with the level of noise to the VLS. Signal strength variation in a VLS causes spectral shifting to occur causing errors in applications.

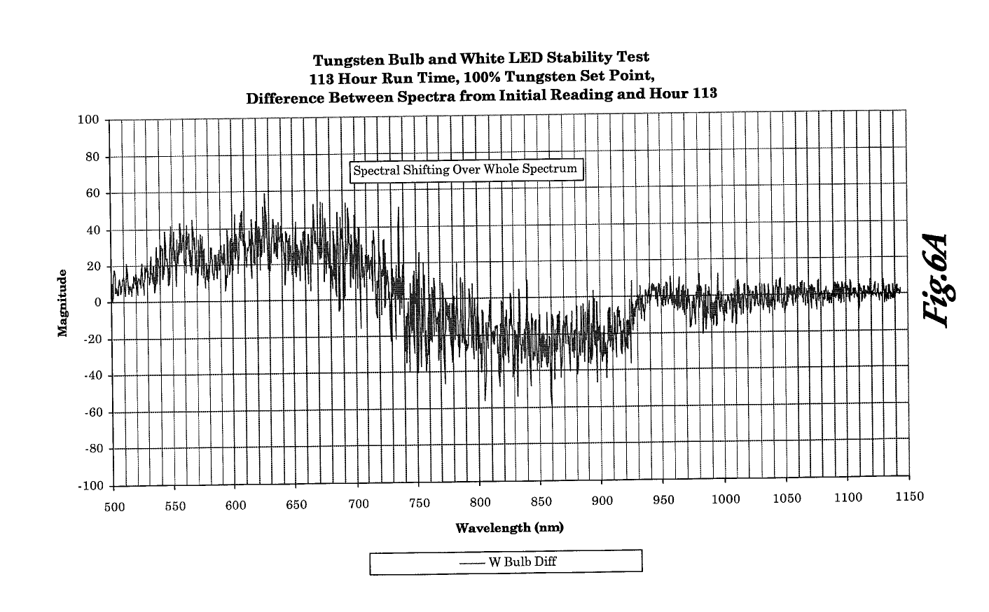

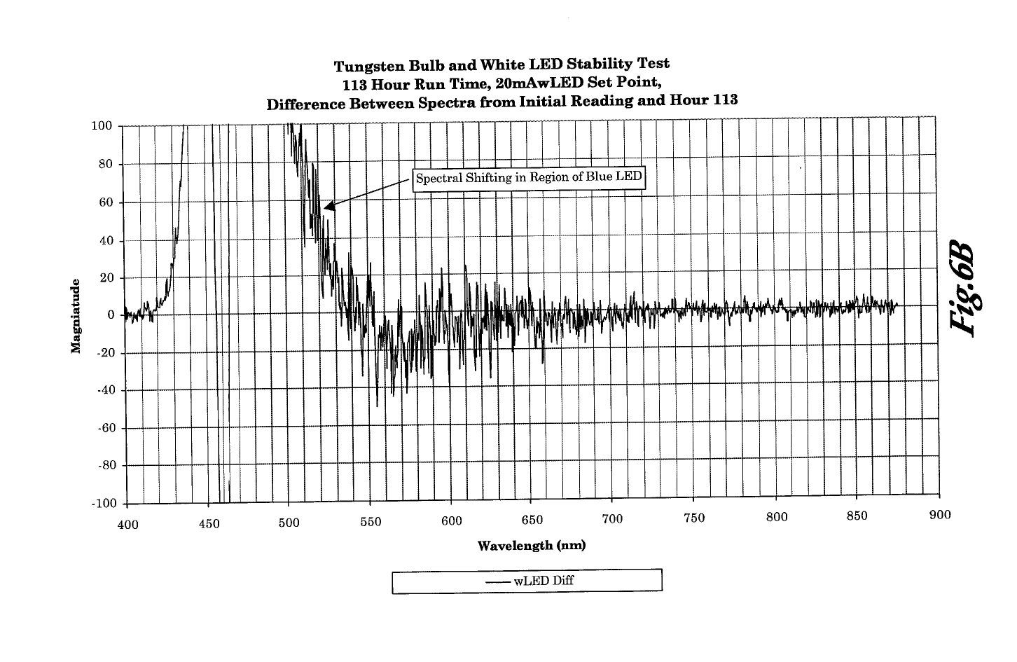

FIGS. 6A and 6B are diagrams illustrating the spectra of a tungsten light source and a wLED between an initial reading and a final reading. More specifically, an initial reading at hour at the beginning of a 113-hour run was made recording the spectra of both light sources. At the 113-hour point another spectra recording was made. As is readily apparent from FIG. 6A, there is a significant amount of spectral shifting for the tungsten light source throughout the entire spectrum. The amount of shifting from 600 nm through 900 nm is relatively minor for the wLED shown in FIG. 6B as compared to the tungsten light source. The spectral shifting for the wLED occurs in the blue line and there is very little shifting in the phosphor emissions region. Between 700 nm and 850 nm the tungsten bulb's magnitude approximately varies between 50 and −60 (FIG. 6A) in magnitude whereas the wLED only varies approximately between −15 and 15 in magnitude in the same region (FIG. 6B). The plot shown in FIG. 6B is magnified in amplitude to show detail causing the signal from the blue LED from about 440 nm to 500 nm to be off scale and not reliably readable in the figure. With less spectral shifting end point times measurements remain more consistent. Additionally, the stable spectral light source of the wLED allows color of the target to be detected more accurately than with a VLS. For example, for Shallow Trench Isolation film on a semiconductor wafer (STI) and Inter Layer Dielectric film on a semiconductor wafer (ILD) films where the color of the wafer is used to determine end point a wLED provides a spectrally stable light source to aid in determining the endpoint.

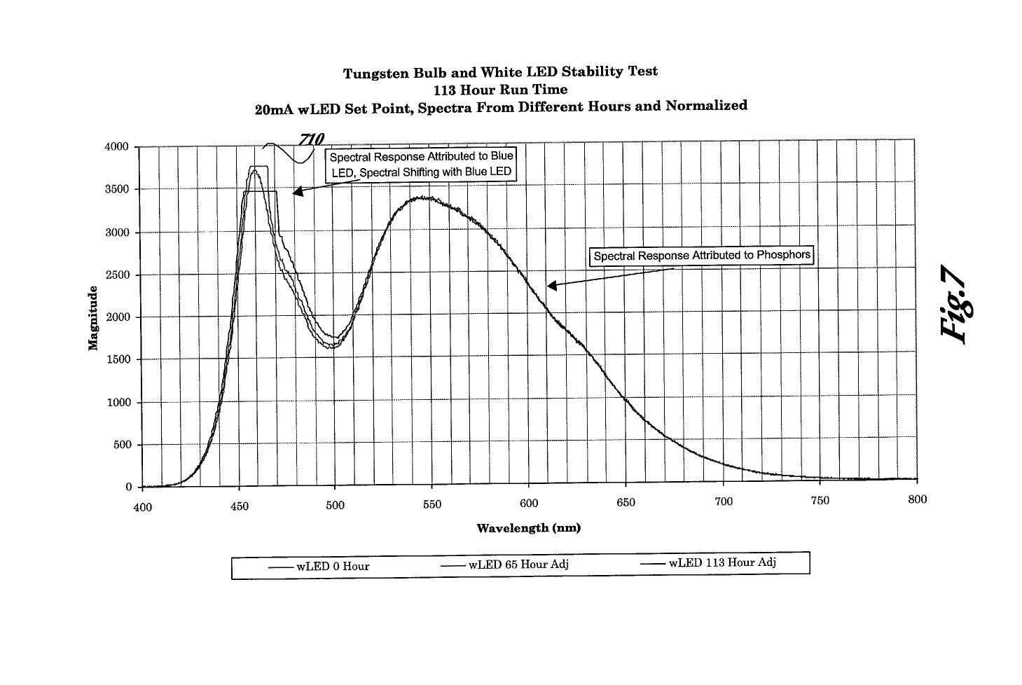

FIG. 7 shows an exemplary spectral signature for a wLED over a 113 hour time period. As can be seen by referring to FIG. 7, the peak 710 around 455 nm is due to the blue LED that is the basis of the wLED. Around peak 710 is the spectral response attributed to the blue LED. It can be seen that spectral shifting occurs throughout the 113 hour run period at peak 710. The “flat-topped” data from about 460 nm to 470 nm is the result of the data gathering system overloading with intensity in that range, but does not change the response in the desired wavelength range of the phosphor. Conversely, however, between approximately 550 nm and up, the spectral response is attributed to the phosphors and the spectral response is stable. The blue LED is the photon source for the phosphors causing the phosphors of the LED to fluoresce. The spectral signature past peak 1110 is due to the selected phosphors. For example, the phosphor layer could be Yttrium Aluminum Garnet excited by a blue Gallium Nitride chip. The phosphor material may also be the phosphor contained in Nichia product number NSPW500BS.

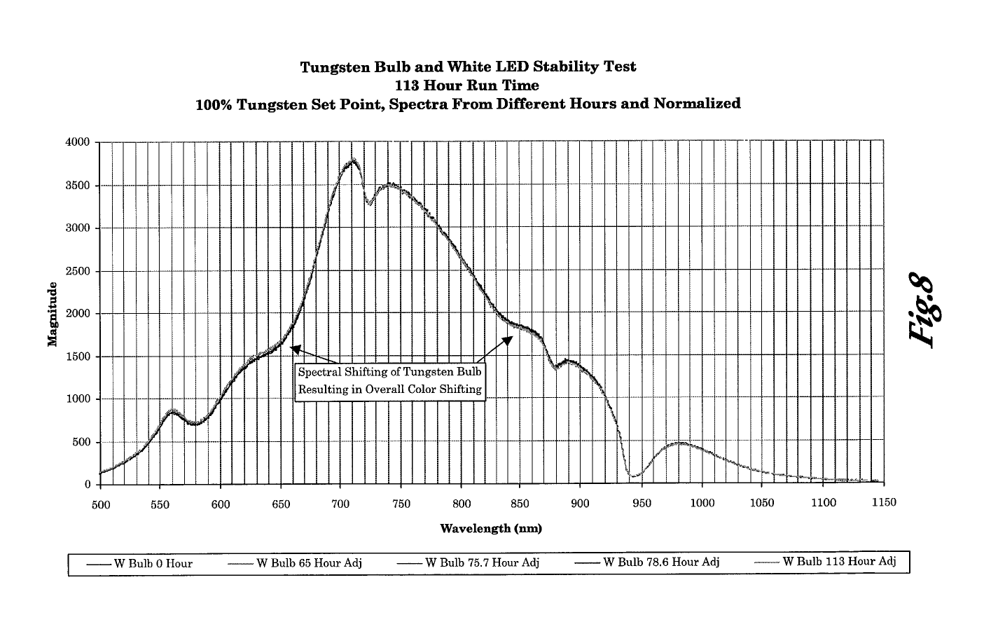

FIG. 8 shows an exemplary spectral signature for a tungsten light source over a 113-hour time period. As can be seen by referring to FIG. 8, spectral shifting of the tungsten bulb occurs throughout the wavelengths resulting in overall color shifting. There is not a wavelength region where the tungsten light source is spectrally stable.

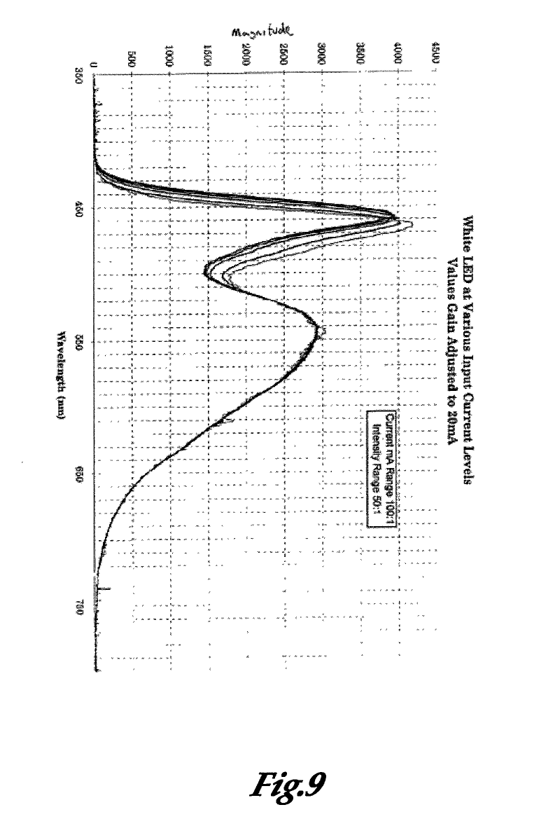

FIG. 9 is an exemplary illustration of spectral stability of a white LED at various input current levels. According to this particular example, a wLED is mounted with the end of the fiber optical path butted up against the wLED. A power supply is attached to the wLED with a current meter in line. The wLED is set to an input current level of 20 mA and the optical path tuned to have a maximum signal strength of just under 4000 counts at 5 ms integration time. The current level is then varied from 0.2 mA to 20 mA in discrete steps. In order to compensate for the decreased photons at the lower current settings the integration time is adjusted to maintain the signal strength between 3000 and 4000 counts. This adjustment helps to minimize channel-to-channel CCD noise as well as to minimize the amount of signal gain adjustments in order to directly compare the wLED at different current levels. The adjustment of the integration time affects the intensity of the wLED but does not affect the spectral shape. In this particular example, mercury lines affect the spectral shape slightly of the wLED at the lower current levels due to the presences of overhead fluorescence lights and because the wLED and the optical fiber ends are not shielded from external light. Referring to FIG. 9, it can be seen that from 520 nm and above the spectral shape remains constant and no spectral shifting occurs in the phosphor emissions. The spectral output from the phosphors is spectrally independent from the photon source where there is not overlap. The peak from 430 nm to 490 nm is due to the blue LED that is the basis of the wLED. Adjusting the intensity of the light source changes the overall photon output without changing the spectral shape. This is not true regarding a VLS, such as a tungsten light source.

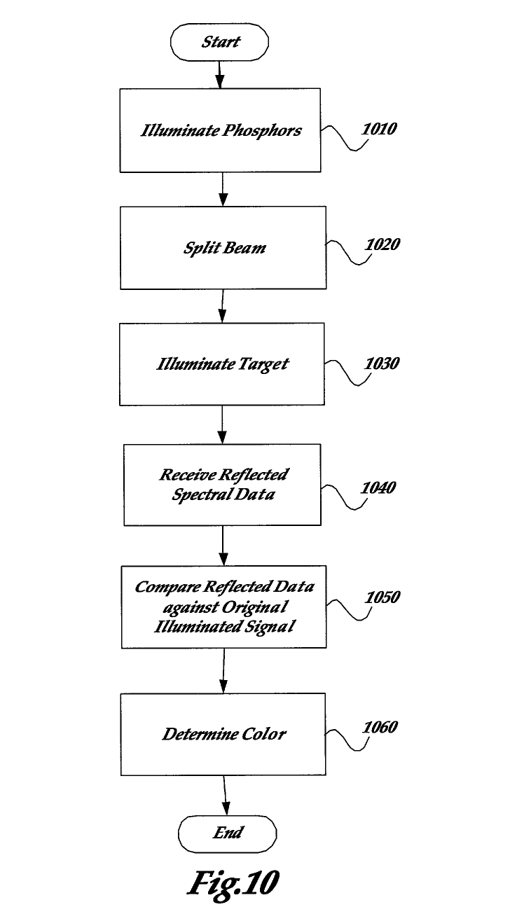

FIG. 10 shows a logical flow for utilizing a spectrally stable light source to determine color of an object according to one embodiment of the invention. After a start block, the logic steps to a block 1010 at which point the phosphors are illuminated by a light source to create a spectrally stable light source. The logic transitions to a block 1020 where the light source beam is split to create at least two light sources. One beam is directed to illuminate a target (block 1030) and another beam is used as a reference beam. Moving to a block 1040, the reflected portion of the split beam directed at the target is received. The reflected spectral data is compared to the initial beam (block 1050) and the color of the target is determined (block 1060). The spectral data may be analyzed by many different methods to determine the color, as is known by those skilled in the art. As will be appreciated by those of ordinary skill in the art, many different levels of colors may be reported depending on the processing chose. The logical flow then ends.

The embodiments of the optical system and optical EPD system described above are illustrative of the principles of the present invention and are not intended to limit the invention to the particular embodiments described. Other embodiments of the present invention can be adapted for use in many different applications. Accordingly, while the preferred embodiment of the invention has been illustrated and described, it will be appreciated that various changes can be made therein without departing from the spirit and scope of the invention. Since many embodiments of the invention can be made without departing from the spirit and scope of the invention, the invention resides in the claims hereinafter appended.

We claim:

1. An apparatus for providing a spectrally stable light source, comprising:
an excitation source;
a phosphor material placed so that the excitation source excites the phosphor material and produces the spectrally stable light source, the phosphor material being selected to emit photons over a specific spectral range;
a fiber optic cable assembly having a first end and a second end, wherein the fiber optic cable is configured to propagate light from the spectrally stable light source toward a target;
a light sensor coupled to the second end of the fiber optic cable assembly, wherein the light sensor is configured to receive reflected spectral data from the target through the fiber optic cable assembly; and
a computer coupled to the light sensor, wherein the computer is configured to analyze the reflected spectral data.

2. The apparatus of claim 1, wherein the fiber optic cable assembly includes a first fiber optic cable to propagate light to the target and a second fiber optic cable to propagate the reflected spectral data from the target.

3. The apparatus of claim 1, wherein the excitation source is a blue light emitting laser.

4. The apparatus of claim 1, wherein the excitation source is a blue light emitting diode.

5. The apparatus of claim 3, wherein the spectrally stable light source is configured to output light in a continuous spectrum in the bandwidth range of 550 to 1000 nanometers.

6. The apparatus of claim 1, wherein the fiber optic cable assembly includes a single or bundled fiber optic cable to propagate light to the target and reflected spectral data from the target.

7. The apparatus of claim 1, wherein the computer is further configured to reduce the noise in the reflected spectral data.

8. The apparatus of claim 1, wherein the computer is further configured to:
generate an endpoint signal related to the polishing of a wafer;
generate a stop polishing command by comparing the endpoint signal to at least one predetermined criterion; and
communicate the stop polishing command to a chemical mechanical polishing system.

9. The apparatus of claim 7, wherein the computer is configurable to generate the endpoint signal while the chemical mechanical polishing system is polishing the wafer.

10. A color-detection system utilizing a spectrally stable light source to determine a color of a target, comprising:
an excitation source directed at a phosphor material having luminescence that produces the spectrally stable light source;
a fiber optic cable assembly having a first end and a second end, wherein the fiber optic cable assembly is configured to propagate light from the spectrally stable light source to illuminate at least a portion of the target or using a light pipe to propagate light from the end of the fiber to the target;
a light sensor coupled to the second end of the fiber optic cable assembly, wherein the light sensor is configured to receive light reflected from the target through the fiber optic cable assembly, the light sensor being further configured to generate data corresponding to a spectrum of the reflected light; and
a computer coupled to the light sensor, wherein the computer is configured to generate the color of the target as a function of the data from the light sensor.

11. The system of claim 10, wherein the fiber optic cable assembly includes a first fiber optic cable to propagate light to the target and a second fiber optic cable to propagate reflected light from the target.

12. The system of claim 10, wherein the fiber optic cable assembly includes a single fiber or bundled optic cable to propagate light to the target and reflected light from the target.

13. The system of claim 10, wherein the spectrally stable light source is configured to output light in a continuous spectrum in the bandwidth range of 600 to 1000 nanometers.

14. The system of claim 10, wherein the phosphor is chosen to emit light within a spectral region of interest with the excitation source being of shorter wavelength than the spectral region of interest.

15. The system of claim 10, wherein the excitation source is an electron source of sufficiently short wavelength to excite the phosphor material.

16. A method of producing a spectrally stable light source to determine the color of an object, comprising:
(a) directing an excitation source at a phosphor material such that the phosphor material is excited to create the spectrally stable light source;
(b) selecting the phosphor material based on the desired spectrum of the spectrally stable light source;
(c) splitting the spectrally stable light source into a reference beam and an illumination beam;
(d) illuminating at least a portion of the object with the illumination beam;
(e) receiving reflected spectral data from the object;
(f) comparing the reflected spectral data to the reference beam; and
(e) determining a color based on the comparison.

17. The method of claim 16, wherein the desired spectrum ranges between wavelengths of 600 to 800 nanometers.

18. The method of claim 16, further comprising arranging a fiber optic cable assembly such that the fiber optic cable assembly propagates the spectrally stable light to the object and the reflected spectral data from the object.

19. The method of claim 18, wherein the fiber optic cable assembly includes a single fiber optic cable to propagate the light and the reflected light.

20. The method of claim 18, wherein the fiber optic cable assembly includes a first fiber optic cable to propagate the spectrally stable light and a second fiber optic cable to propagate the reflected spectral data.

21. An apparatus for detecting an endpoint during polishing of a wafer surface, the apparatus comprising:
means for providing a relative rotation between the wafer surface and a pad, the pad contacting the surface during a polishing process of the wafer surface;
means for illuminating at least a portion of the surface with a spectrally stable light having a predetermined spectrum while the wafer surface is being polished;
means for generating reflected spectrum data corresponding to a spectrum of light reflected from the region while the wafer surface is being polished; and
means for determining a value as a function of amplitudes of at least two individual wavelength bands of the reflected spectrum data.
